(19) United States
(12) Patent Application Publication
(10) Pub. No.: US 2025/0360774 A1
(43) Pub. Date: Nov. 27, 2025

(54) SEAT HEATING CONTROL SYSTEM, METHOD, AND VEHICLE

(71) Applicant: AutoX, Inc., Grand Cayman (KY)

(72) Inventors: Jianxiong Xiao, Shenzhen (CN); Tao Ma, Shenzhen (CN); Jinheng Lu, Shenzhen (CN); Yilong Gao, Shenzhen (CN)

(73) Assignee: AutoX, Inc., Grand Cayman (KY)

(21) Appl. No.: 19/219,119

(22) Filed: May 27, 2025

(30) Foreign Application Priority Data
May 27, 2024 (CN) 2024106658649

(51) Int. Cl. B60H 1/00

(52) U.S. Cl. CPC B60H 1/00885; B60H 1/00285

(57) ABSTRACT

The disclosure provides a seat heating control system and method that heat the seats by introducing high-pressure gas compressed by the compressor of the air conditioning system into the heat exchanger through an electronic throttle valve that coupled the air conditioning system and the seat heating control system. The high-pressure gas exchanges heat in the heat exchanger to raise the temperature and heat the seat, then flows out of the heat exchanger and re-enters the compressor to achieve circulation of the gas within the air conditioning system. This enables heating when the seat surface temperature is low without additional heating consumption, improving the vehicle's economy, power performance, and environmental friendliness.

### CROSS REFERENCE TO RELATED APPLICATION

This non-provisional patent application claims priority under 35 U. S. C. § 119 from Chinese Patent Application No. 202410665864.9 filed on May 27, 2024, the entire content of which is incorporated herein by reference.

### TECHNICAL FIELD

The disclosure relates to the field of vehicle technology, particularly to a seat heating control system, method, and vehicle.

### BACKGROUND

In winter, due to low ambient temperatures, the surface temperature of seats in the passenger compartment is also relatively low, affecting the riding comfort of drivers or passengers. Currently, many high-end vehicles employ seat heating control systems to improve seating comfort. Such seat heating control systems typically use electric heating wires to heat the seats. However, using electric heating wires to heat the seats increases the vehicle's power consumption, leading to increased load on the vehicle's generator and power consumption, thereby increasing fuel or electricity consumption, which is detrimental to the vehicle's economy, power performance, and environmental friendliness.

### SUMMARY

In view of this, it is necessary to propose a seat heating control system, method, and vehicle to reduce the vehicle's energy consumption by heating the seats using a recyclable cooling medium from the vehicle.

In a first aspect, an embodiment of the disclosure provides a seat heating control system applied to a vehicle equipped with seats, the vehicle comprising an air conditioning system. The air conditioning system comprises a compressor with an outlet, the compressor being configured to compress low-pressure gas into high-pressure gas for output through the outlet. The seat heating control system is in communication with the compressor. The seat heating control system includes a temperature sensor, a heat exchanger, an electronic throttle valve, and a controller. The temperature sensor is configured to sense the surface temperature of the seat. The heat exchanger is disposed on the seat. The electronic throttle valve is located between the outlet and the heat exchanger and is configured to communicate or isolate the compressor from the heat exchanger. When the compressor is connected to the heat exchanger, high-pressure gas flows into the heat exchanger for heat exchange, generating heat to heat the seat. The controller includes a judging unit and a control unit. The judging unit is configured to determine whether the surface temperature is below a predetermined heating temperature. When the surface temperature is determined to be below the predetermined heating temperature, the control unit is configured to control the electronic throttle valve to open. When the surface temperature is determined to reach a predetermined cutoff temperature, the control unit is configured to control the electronic throttle valve to close.

In a second aspect, an embodiment of the disclosure provides a seat heating control method applied to a seat heating control system, the seat heating control system being applied to a vehicle equipped with seats, the vehicle comprising an air conditioning system. The air conditioning system comprises a compressor with an outlet, the compressor being configured to compress low-pressure gas into high-pressure gas for output through the outlet. The seat heating control system is in communication with the compressor. The seat heating control system includes a temperature sensor, a heat exchanger disposed on the seat, an electronic throttle valve, and a controller. The electronic throttle valve is located between the outlet and the heat exchanger and is configured to communicate or isolate the compressor from the heat exchanger. When the compressor is connected to the heat exchanger, high-pressure gas flows into the heat exchanger for heat exchange, generating heat to heat the seat. The seat heating control method includes: sensing the surface temperature of the seat using the temperature sensor; determining whether the surface temperature is below a predetermined heating temperature; controlling the electronic throttle valve to open when the surface temperature is determined to be below the predetermined heating temperature; and controlling the electronic throttle valve to close when the surface temperature is determined to reach a predetermined cutoff temperature.

In a third aspect, an embodiment of the disclosure provides a vehicle equipped with seats, the vehicle comprising an air conditioning system. The air conditioning system comprises a compressor with an outlet, the compressor being configured to compress low-pressure gas into high-pressure gas for output through the outlet. The vehicle includes a vehicle body, the aforementioned seat heating control system disposed on the vehicle body, and a main control device. The seat heating control system is in communication with the compressor. The main control device includes a memory and a processor. The memory is configured to store computer programs. The processor is configured to execute the computer programs to implement the seat heating control method, which includes: sensing the surface temperature of the seat using the temperature sensor; determining whether the surface temperature is below a predetermined heating temperature; controlling the electronic throttle valve to open when the surface temperature is determined to be below the predetermined heating temperature; and controlling the electronic throttle valve to close when the surface temperature is determined to reach a predetermined cutoff temperature.

The aforementioned seat heating control system, method, and vehicle heat the seats by controllably introducing high-pressure gas compressed by the compressor of the air conditioning system into the heat exchanger through an electronic throttle valve that connects the air conditioning system and the seat heating control system. The high-pressure gas exchanges heat in the heat exchanger to raise the temperature and heat the seat, then flows out of the heat exchanger and re-enters the compressor to achieve circulation of the gas within the air conditioning system. This enables heating when the seat surface temperature is low without additional heating consumption, improving the vehicle's economy, power performance, and environmental friendliness.

### BRIEF DESCRIPTION OF THE DRAWINGS

To more clearly illustrate the technical solutions in the embodiments of the disclosure or in the prior art, the drawings required for the description of the embodiments or the prior art will be briefly introduced below. It is obvious that the drawings in the following description are only some embodiments of the disclosure. For those of ordinary skill in the art, other drawings can be obtained based on these drawings without creative efforts.

FIG. 1 is a schematic internal structural diagram of a seat heating control system in accordance with an embodiment.

FIG. 2 is a perspective view of a heat exchanger in accordance with an embodiment.

FIG. 3 is a front view of the heat exchanger in accordance with an embodiment.

FIG. 4 is a top view of the heat exchanger in accordance with an embodiment.

FIG. 5 is a first flowchart of a seat heating control method in accordance with an embodiment.

FIG. 6 is a second flowchart of the seat heating control method in accordance with an embodiment.

FIG. 7 is a schematic diagram of a vehicle in accordance with an embodiment.

The objectives, functional characteristics, and advantages of the disclosure will be further explained in conjunction with the embodiments and with reference to the accompanying drawings.

### DETAILED DESCRIPTION OF THE EMBODIMENTS

To facilitate a clearer understanding of the objectives, technical solutions, and advantages of the disclosure, a detailed description is provided below in conjunction with the accompanying drawings and embodiments. It should be understood that the specific embodiments described herein are intended to explain the disclosure only and are not intended to limit the scope of the disclosure. All other embodiments obtained by those of ordinary skill in the art without creative efforts based on the embodiments of the disclosure shall fall within the protection scope of the disclosure.

The terms “first,” “second,” “third,” “fourth,” etc. (if present) in the specification, claims, and the aforementioned drawings of the disclosure are used to distinguish similar objects and are not necessarily used to describe a specific sequence or order. It should be understood that the data used in this manner can be interchanged under appropriate circumstances. In other words, the described embodiments can be implemented in sequences other than those illustrated or described herein. Additionally, the terms “include” and “have,” as well as any variations thereof, are intended to cover non-exclusive inclusions. For example, a process, method, system, product, or device that includes a series of steps or units is not necessarily limited to those steps or units clearly listed but may include other steps or units not clearly listed or inherent to such processes, methods, products, or devices.

It should be noted that the descriptions involving “first,” “second,” etc., in the disclosure are only for descriptive purposes and should not be construed as indicating or implying their relative importance or implicitly indicating the number of technical features indicated. Thus, features defined with “first,” “second,” etc., may explicitly or implicitly include one or more of such features. Additionally, the technical solutions among various embodiments can be combined with each other, but such combinations must be achievable by those of ordinary skill in the art. When combinations of technical solutions are contradictory or unachievable, such combinations are deemed not to exist and are not within the scope of protection claimed by the disclosure.

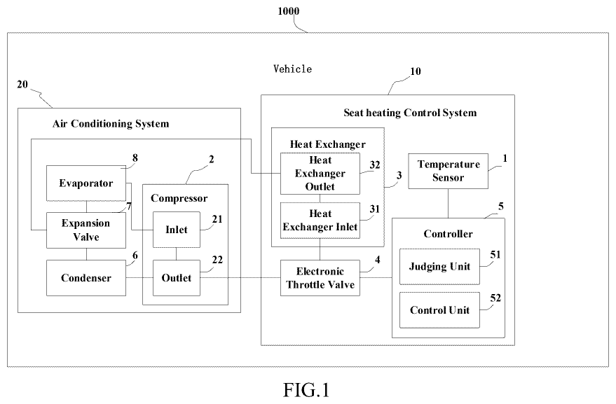

Referring to FIG. 1, which is a schematic internal structural diagram of a seat heating control system in accordance with an embodiment, the disclosure provides a seat heating control system 10. The seat heating control system 10 is applied to a vehicle 1000 equipped with seats. The vehicle 1000 includes, but is not limited to, fuel vehicles, pure electric vehicles, hybrid vehicles, etc. In the disclosure, the vehicle 1000 includes an air conditioning system 20. The air conditioning system 20 includes a compressor 2 with an outlet 22. The compressor 2 is configured to compress low-pressure gas into high-pressure gas for output through the outlet 22. Both the low-pressure gas and the high-pressure gas are different forms of a cooling medium participating in heat exchange in the air conditioning system 20. The cooling medium exists in different forms such as gaseous and liquid states and at different pressures such as high and low pressures in the air conditioning system 20, which will not be elaborated on here. In the disclosure, the seat heating control system 10 is in communication with the compressor 2 to achieve seat heating and gas circulation by combining the different forms and pressures of the gas in the air conditioning system 20, thereby improving the economy, power performance, and environmental friendliness of the vehicle 1000. The specific features of each component in the seat heating control system 10 will be elaborated below.

As shown in FIG. 1, the seat heating control system 10 includes a temperature sensor 1, a heat exchanger 3, an electronic throttle valve 4, and a controller 5. The temperature sensor 1 is configured to sense the surface temperature of the seat. The temperature sensor 1 can be disposed at corresponding positions of the vehicle 1000 according to sensing needs, such as on the seat surface or beneath the seat. The heat exchanger 3 is disposed on the seat and is configured to heat the seat. The specific features of the heat exchanger 3 will be elaborated in detail below.

In this embodiment, the electronic throttle valve 4 is located between the outlet 22 and the heat exchanger 3. The electronic throttle valve 4 is configured to communicate or isolate the compressor 2 from the heat exchanger 3. Specifically, the heat exchanger 3 is provided with a heat exchanger inlet 31 and a heat exchanger outlet 32. The electronic throttle valve 4 is configured to couple the outlet 22 and the heat exchanger inlet 31. When the compressor 2 is couple to the heat exchanger 3, high-pressure gas flows into the heat exchanger 3 for heat exchange, generating heat to heat the seat.

In this embodiment, the controller 5 is configured to control the electronic throttle valve 4 to perform different operations, such as opening, increasing (decreasing) gas flow rate, closing, etc. Specifically, the controller 5 includes a judging unit 51 and a control unit 52.

The judging unit 51 is configured to determine whether the surface temperature is below a predetermined heating temperature.

When the surface temperature is determined to be below the predetermined heating temperature, the control unit 52 is configured to control the electronic throttle valve 4 to open, thereby allowing high-pressure gas from the compressor 2 to enter the heat exchanger 3 for heat exchange and temperature rise to heat the seat. That is, the controller 5 can be used to control the electronic throttle valve 4 to conduct when the seat needs to be heated, allowing high-pressure gas to enter the heat exchanger 3 and initiating the seat heating process. When the surface temperature is determined to reach a predetermined cutoff temperature, the control unit 52 is configured to control the electronic throttle valve 4 to close, thereby preventing high-pressure gas from the compressor 2 from entering the heat exchanger 3 and shutting down the seat heating process.

Furthermore, when the judging unit 51 judges that the surface temperature of the seat is greater than the predetermined heating temperature and less than the predetermined cutoff temperature, the control unit 52 is further configured to control the electronic throttle valve 4 to adjust the flow rate of the high-pressure gas flowing into the heat exchanger 3. Specifically, when the surface temperature is determined to be greater than a predetermined adjustment temperature and less than the predetermined cutoff temperature, the control unit 52 controls the electronic throttle valve 4 to decrease the flow rate. The predetermined heating temperature, predetermined adjustment temperature, and predetermined cutoff temperature are all temperatures used to adjust the electronic throttle valve 4. That is, the electronic throttle valve 4 can perform operations such as opening and increasing the flow rate, decreasing the flow rate, and closing based on the measured different surface temperatures, thereby adjusting the seat heating. The predetermined heating temperature is the temperature at which the seat surface temperature is too low and needs to be heated to improve seating comfort. The predetermined cutoff temperature is the temperature at which the seat temperature is already high enough and excessive heating needs to be avoided. The predetermined adjustment temperature is greater than the predetermined heating temperature and less than the predetermined cutoff temperature.

For example, the predetermined heating temperature, predetermined adjustment temperature, and predetermined cutoff temperature are set to 10° C., 20° C., and 30° C., respectively. When the judging unit 51 determines that the surface temperature sensed by the temperature sensor 1 is below 10° C., the temperature sensor 1 transmits a working signal to the controller 5. After receiving the working signal, the control unit 52 controls the electronic throttle valve 4 to conduct, allowing high-pressure gas to flow through the heat exchanger 3, thereby heating the seat. When the judging unit 51 determines that the surface temperature sensed by the temperature sensor 1 rises to 20° C., the control unit 52 controls the electronic throttle valve 4 to decrease the flow rate of the high-pressure gas flowing into the heat exchanger 3, preventing excessive heating of the seat. When the judging unit 51 determines that the surface temperature sensed by the temperature sensor 1 rises to 30° C., the controller 5 controls the electronic throttle valve 4 to close to ensure seating comfort. The specific features of the heat exchanger 3 will be elaborated below.

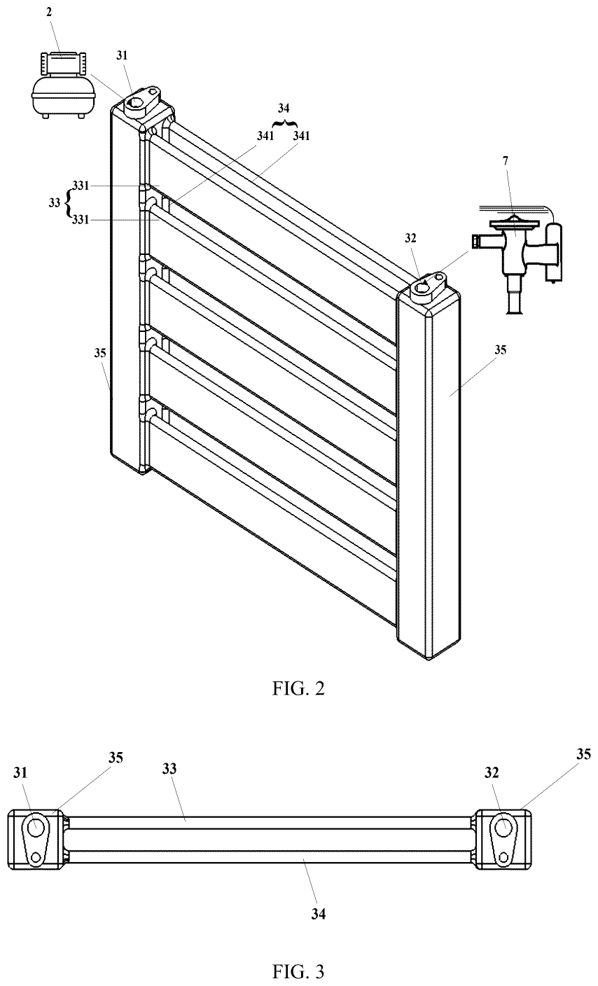

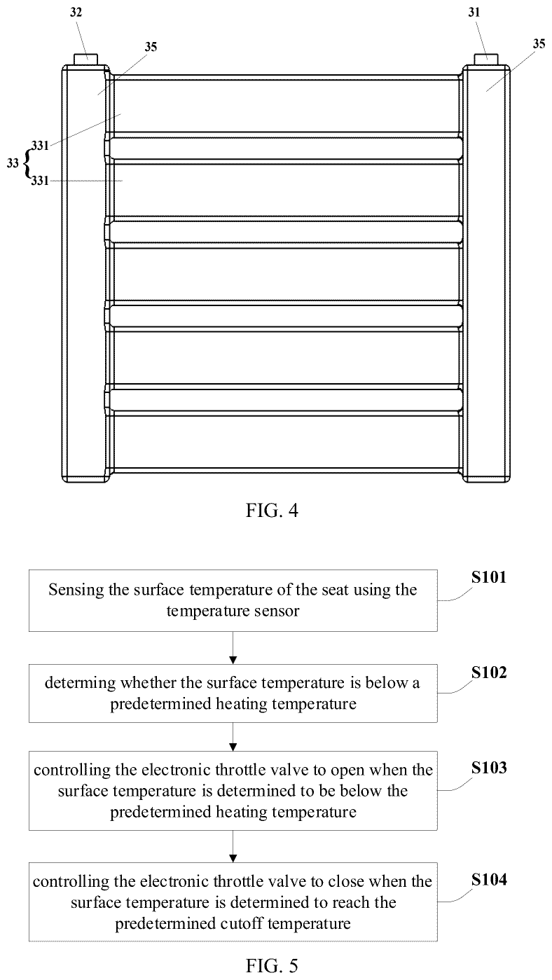

Referring to FIGS. 2-4, which are a perspective view, a front view, and a top view of the heat exchanger in accordance with an embodiment, respectively.

As shown in FIGS. 2-4, the heat exchanger 3 includes a storage part 35, and a heat exchange part in communication with the storage part 35. The heat exchange part is located on the seat. The storage part 35 stores heat exchange medium for heat exchange with the high-pressure gas, allowing the high-pressure gas to fully liquefy in the heat exchange part, generating a large amount of heat for heat exchange with the heat exchange medium, thereby heating the seat. The heat exchange medium includes at least water to improve the heat transfer effect from the high-pressure gas to the storage part 35 of the heat exchanger 3. That is, the storage part 35 can be a water chamber. The heat exchange medium can also be other media with good heat absorption effects, such as steam or air, which will not be elaborated on here.

Furthermore, the heat exchange part includes an upper heat exchange layer 33 and a lower heat exchange layer 34 in communication. Both the upper heat exchange layer 33 and the lower heat exchange layer 34 are composed of a plurality of heat exchange tubes. That is, the upper heat exchange layer 33 is composed of a plurality of upper heat exchange tubes 331, and the lower heat exchange layer 34 is composed of a plurality of lower heat exchange tubes 341. In the disclosure, the upper heat exchange tubes 331 and the lower heat exchange tubes 341 are heat exchange tubes of the same specification. The heat exchange medium is located in both the upper heat exchange layer 33 and the lower heat exchange layer 34 through the storage part 35 in communication with the heat exchange part. The upper heat exchange layer 33 is adjacent to the seat, and the heat exchange tubes of the upper heat exchange layer 33 are arranged beneath the seat corresponding to the seat shape to fully heat the seat surface and improve the efficiency of seat heating. The upper heat exchange layer 33 is connected to the heat exchanger inlet 31, and the lower heat exchange layer 34 is connected to the heat exchanger outlet 32. The heat exchanger inlet 31 is connected or isolated from the outlet 22 via the electronic throttle valve 4. In the disclosure, both the upper heat exchange layer 33 and the lower heat exchange layer 34 are respectively connected to a storage part 35. When the high-pressure gas enters the heat exchanger 3 and flows out of it, it can fully transfer heat to the storage part 35 and then to the upper heat exchange layer 33 and the lower heat exchange layer 34, distributing the heat exchange medium in the upper heat exchange tubes 331 and the lower heat exchange tubes 341, increasing the contact area between the heated portion of the seat and the seat, thereby improving the heating efficiency of the seat. Therefore, in the disclosure, the liquefaction of the high-pressure gas into a gas condensate occurs in the storage part 35 and/or the heat exchange layers of the heat exchanger 3.

It can be understood that neither the upper heat exchange tubes 331 nor the lower heat exchange tubes 341 are provided with fins, reducing damage to the seat while also reducing heat loss from the storage part 35 to the heat exchange tubes caused by the fins enhancing heat transfer between the heat exchange tubes, thereby further improving the heating effect of the high-pressure gas on the seat.

In this embodiment, the high-pressure gas participating in the heat exchange can also be recycled through the connection between the air conditioning system 20 and the seat heating control system 10, improving the environmental friendliness of seat heating. Specifically, after the high-pressure gas exchanges heat with the heat exchange medium in the heat exchanger 3, it liquefies and is converted into a gas condensate. The gas condensate flows out from the heat exchanger outlet 32 to the air conditioning system 20 to complete the recycling of the high-pressure gas. The specific features of the air conditioning system 20 will be further elaborated below.

In this embodiment, the air conditioning system 20 further includes a condenser 6, an expansion valve 7, and an evaporator 8. The outlet 22 is also connected to the condenser 6, allowing high-pressure gas output through the outlet 22 and not flowing into the heat exchanger 3 to enter the condenser 6, thereby enabling the high-pressure gas that does not flow into the heat exchanger 3 to still flow into the heat exchanger 3 of the seat heating control system 10 for heat exchange after passing through the air conditioning system 20. Specifically, the condenser 6 is connected to the evaporator 8 via the expansion valve 7. The expansion valve 7 is configured to control the gas flow rate into the evaporator 8. The compressor 2 is also provided with an inlet 21, and the evaporator 8 is connected to the inlet 21. That is, the high-pressure gas flowing through the condenser 6 will partially or fully flow into the compressor 2 through the evaporator 8 to be re-converted into high-pressure gas. Meanwhile, the heat exchanger outlet 32 is also connected to the expansion valve 7, allowing the gas condensate to flow into the evaporator 8 through the expansion valve 7 after flowing out from the heat exchanger outlet 32 and then into the compressor 2 through the inlet 21 to be re-converted into high-pressure gas for flowing into the heat exchanger 3 of the seat heating control system 10 for heat exchange, thereby improving the environmental friendliness of seat heating.

In this embodiment, the vehicle 1000 is equipped with a plurality of seats, meaning that the seat heating control system 10 in the disclosure can heat the plurality of seats in the vehicle 1000. Preferably, each seat is equipped with a temperature sensor 1 and a heat exchanger 3, and each heat exchanger 3 is connected to the compressor 2 through a corresponding electronic throttle valve 4.

Referring to FIG. 5, which is a first flowchart of a seat heating control method in accordance with an embodiment. The seat heating control method providing a seat heating control system 10. The vehicle 1000 includes an air conditioning system 20. The air conditioning system 20 includes a compressor 2 with an outlet 22. The compressor 2 is configured to compress low-pressure gas into high-pressure gas for output through the outlet 22. The seat heating control system 10 is in communication with the compressor 2. The seat heating control system 10 includes a temperature sensor 1, a heat exchanger 3 disposed on the seat, an electronic throttle valve 4, and a controller 5. The electronic throttle valve 4 is located between the outlet 22 and the heat exchanger 3 and is configured to communicate or isolate the compressor 2 from the heat exchanger 3. When the compressor 2 is connected to the heat exchanger 3, high-pressure gas flows into the heat exchanger 3 for heat exchange, generating heat to heat the seat. The seat heating control method further includes steps S101-S104.

In the Step S101: sensing the surface temperature of the seat using the temperature sensor.

In the Step S101, the temperature sensor 1 is configured to sense the surface temperature of the seat. The temperature sensor 1 can be disposed at corresponding positions of the vehicle 1000 according to sensing needs, such as on the seat surface or beneath the seat.

In the Step S102: determining whether the surface temperature is below a predetermined heating temperature.

In step S102, the controller 5 includes a judging unit 51 and a control unit 52. The judging unit 51 is configured to determine whether the surface temperature measured by the temperature sensor 1 is low enough to require initiating the seat heating process.

In step S103: controlling the electronic throttle valve to open when the surface temperature is determined to be below the predetermined heating temperature.

In the step S103, the predetermined heating temperature is the temperature at which the seat surface temperature is too low and needs to be heated to improve seating comfort. When the outlet 22 is connected to the heat exchanger inlet 31, high-pressure gas from the compressor 2 enters the heat exchanger inlet 31 from the outlet 22, allowing the high-pressure gas to exchange heat with the heat exchange medium in the heat exchanger 3 and rise in temperature, thereby heating the seat.

In the step S104: controlling the electronic throttle valve to close when the surface temperature is determined to reach the predetermined cutoff temperature.

In the step S104, the predetermined cutoff temperature is the temperature at which the seat temperature is already high enough and excessive heating needs to be avoided. When the surface temperature is determined to reach the predetermined cutoff temperature, the electronic throttle valve 4 is controlled to close, disconnecting the outlet 22 from the heat exchanger inlet 31, thereby preventing high-pressure gas from the compressor 2 from entering the heat exchanger 3 and shutting down the seat heating process.

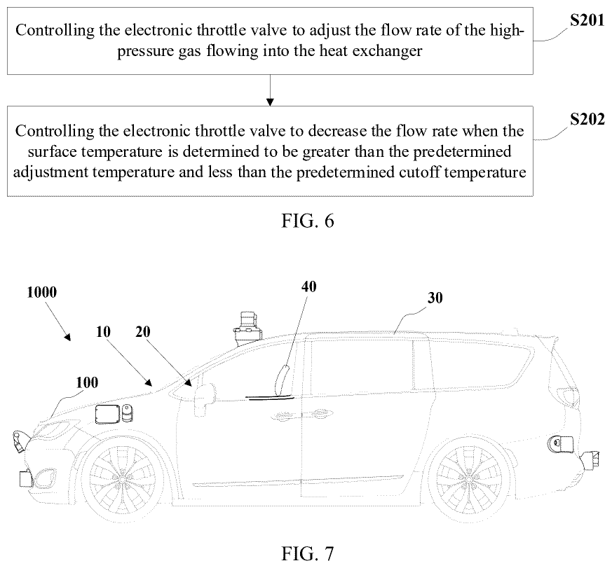

Referring to FIG. 6, which is a second flowchart of the seat heating control method in accordance with an embodiment, the seat heating control method further includes steps S201-S202.

In the step S201: controlling the electronic throttle valve to adjust the flow rate of the high-pressure gas flowing into the heat exchanger.

In the step S201, the predetermined adjustment temperature is less than the predetermined cutoff temperature and greater than the predetermined heating temperature. In the disclosure, the predetermined heating temperature, predetermined adjustment temperature, and predetermined cutoff temperature are all temperatures used to adjust the electronic throttle valve 4. That is, the electronic throttle valve 4 can perform operations such as opening and increasing the flow rate, decreasing the flow rate, and closing based on the measured different surface temperatures, thereby adjusting the seat heating. The predetermined adjustment temperature is greater than the predetermined heating temperature and less than the predetermined cutoff temperature.

In the step S202: controlling the electronic throttle valve to decrease the flow rate when the surface temperature is determined to be greater than the predetermined adjustment temperature and less than the predetermined cutoff temperature.

For example, the predetermined heating temperature, predetermined adjustment temperature, and predetermined cutoff temperature are set to 10° C., 20° C., and 30° C., respectively. When the temperature sensor 1 senses that the surface temperature of the seat is below 10° C., the electronic throttle valve 4 is controlled to open by receiving the working signal from the temperature sensor 1, allowing high-pressure gas from the compressor 2 to flow through the heat exchanger 3, thereby heating the seat. When the temperature sensor 1 senses that the surface temperature of the seat rises to 20° C., the electronic throttle valve 4 is controlled to decrease the flow rate of the high-pressure gas flowing into the heat exchanger 3, preventing excessive heating of the seat. When the temperature sensor 1 senses that the surface temperature of the seat rises to 30° C., the electronic throttle valve 4 is controlled to close to ensure seating comfort.

Referring to FIG. 7, which is a schematic diagram of a vehicle in accordance with an embodiment, the disclosure also provides a vehicle 1000. The vehicle 1000 is equipped with seats 40. The vehicle 1000 includes an air conditioning system 20. The air conditioning system 20 includes a compressor 2 with an outlet 22. The compressor 2 is configured to compress low-pressure gas into high-pressure gas for output through the outlet 22. The vehicle 1000 includes a vehicle body 30, a seat heating control system 10 disposed on the vehicle body 30, and a main control device. The seat heating control system is in communication with the compressor 2. The seat heating control system 10 is at least elaborated in detail in the aforementioned seat heating control system 10 and will not be elaborated on further here.

In the aforementioned embodiments, the high-pressure gas compressed by the compressor of the air conditioning system, in conjunction with the electronic throttle valve used to connect the air conditioning system and the seat heating control system, controllably enters the heat exchanger for heat exchange and temperature rise to heat the seat, then flows out of the heat exchanger and re-enters the compressor to achieve circulation of the gas within the air conditioning system. This enables heating when the seat surface temperature is low without additional heating consumption, improving the vehicle's economy, power performance, and environmental friendliness.

Obviously, those skilled in the art can make various modifications and variations to the disclosure without departing from the spirit and scope of the disclosure. In this case, if such modifications and variations of the disclosure fall within the scope of the claims and their equivalents, the disclosure is also intended to include these modifications and variations.

The above-listed are merely preferred embodiments of the disclosure and are not intended to limit the protection scope of the disclosure. Therefore, equivalent changes made according to the claims of the disclosure still fall within the scope covered by the disclosure.

1. A seat heating control system, the vehicle comprising an air conditioning system, the air conditioning system comprising a compressor with an outlet, the compressor being configured to compress low-pressure gas into high-pressure gas for output through the outlet, the seat heating control system is in communication with the compressor, the seat heating control system comprises:
a temperature sensor configured to sense the surface temperature of the seat;
a heat exchanger disposed on the seat;
an electronic throttle valve located between the outlet and the heat exchanger and configured to communicate with or isolate the compressor from the heat exchanger. When the compressor is connected to the heat exchanger, high-pressure gas flows into the heat exchanger for heat exchange, generating heat to heat the seat; and
a controller configured to determine whether the surface temperature is below a predetermined heating temperature; and control the electronic throttle valve to open when the surface temperature is determined to be below the predetermined heating temperature, and configured to control the electronic throttle valve to close when the surface temperature is determined to reach a predetermined cutoff temperature.

2. The seat heating control system according to claim 1, wherein when the surface temperature is determined to be greater than the predetermined heating temperature and less than the predetermined cutoff temperature, the electronic throttle valve adjusts the flow rate of the high-pressure gas flowing into the heat exchanger.

3. The seat heating control system according to claim 2, wherein when the surface temperature is determined to be greater than a predetermined adjustment temperature and less than the predetermined cutoff temperature, the electronic throttle valve decrease the flow rate, wherein the predetermined adjustment temperature is greater than the predetermined heating temperature and less than the predetermined cutoff temperature.

4. The seat heating control system according to claim 1, wherein the heat exchanger comprises a storage part, and a heat exchange part in communication with the storage part, the heat exchange part is located on the seat, the storage part stores heat exchange medium for heat exchange with the high-pressure gas to heat the seat.

5. The seat heating control system according to claim 4, wherein the heat exchange part comprises an upper heat exchange layer, and a lower heat exchange layer in communication, both the upper heat exchange layer and the lower heat exchange layer are composed of a plurality of heat exchange tubes, the heat exchange medium is located in both the upper heat exchange layer and the lower heat exchange layer, the upper heat exchange layer is adjacent to the seat and connected to a heat exchanger inlet, the lower heat exchange layer is connected to a heat exchanger outlet, the heat exchanger inlet is communicated with or isolated from the outlet via the electronic throttle valve.

6. The seat heating control system according to claim 5, wherein the high-pressure gas, after heat exchange with the heat exchange medium in the heat exchanger, is converted into a gas condensate and flows out from the heat exchanger outlet.

7. The seat heating control system according to claim 6, further comprising a condenser, an expansion valve, and an evaporator, wherein the outlet is further connected to the condenser so that high-pressure gas output through the outlet and not flowing into the heat exchanger enters the condenser; the condenser is coupled to the evaporator via the expansion valve, the expansion valve being configured to control the gas flow rate into the evaporator, the compressor is further provided with an inlet, the evaporator is connected to the inlet, the heat exchanger outlet is further connected to the expansion valve so that the gas condensate, after flowing out from the heat exchanger outlet, flows into the evaporator through the expansion valve and then into the compressor through the inlet to be re-converted into high-pressure gas for flowing into the heat exchanger of the seat heating control system for heat exchange, thereby enhancing the environmental friendliness of seat heating.

8. A seat heating control method for a vehicle, the vehicle comprising an air conditioning system, the air conditioning system comprising a compressor with an outlet, the compressor being configured to compress low-pressure gas into high-pressure gas for output through the outlet, the seat heating control method comprising:
providing seat heating control system, comprising a heat exchanger; an electronic throttle valve configured to couple the outlet and the heat exchanger, and enable the high-pressure gas flows into the heat exchanger for heat exchange, generating heat to heat the seat when the compressor is communicated with the heat exchanger; and a temperature sensor;
sensing a surface temperature of the seat;
determining whether the surface temperature is below a predetermined heating temperature;
controlling the electronic throttle valve to open when the surface temperature is determined to be below the predetermined heating temperature; and
controlling the electronic throttle valve to close when the surface temperature is determined to reach a predetermined cutoff temperature.

9. The seat heating control method according to claim 8, further comprising:
controlling the electronic throttle valve to adjust the flow rate of the high-pressure gas flowing into the heat exchanger, when the surface temperature is determined to be greater than the predetermined heating temperature and less than the predetermined cutoff temperature.

10. The seat heating control method according to claim 9, wherein the heat exchanger comprises a storage part, and a heat exchange part in communication with the storage part, the heat exchange part is located on the seat, the storage part stores heat exchange medium for heat exchange with the high-pressure gas to heat the seat.

11. The seat heating control method according to claim 10, wherein the heat exchange part comprises an upper heat exchange layer, and a lower heat exchange layer in communication, both the upper heat exchange layer and the lower heat exchange layer are composed of a plurality of heat exchange tubes, the heat exchange medium is located in both the upper heat exchange layer and the lower heat exchange layer, the upper heat exchange layer is adjacent to the seat and connected to a heat exchanger inlet, the lower heat exchange layer is connected to a heat exchanger outlet, the heat exchanger inlet is communicated with or isolated from the outlet via the electronic throttle valve.

12. The seat heating control method according to claim 11, wherein the high-pressure gas, after heat exchange with the heat exchange medium in the heat exchanger, is converted into a gas condensate and flows out from the heat exchanger outlet.

13. The seat heating control method according to claim 12, further comprising a condenser, an expansion valve, and an evaporator, the outlet is further connected to the condenser so that high-pressure gas output through the outlet and not flowing into the heat exchanger enters the condenser. The condenser is connected to the evaporator via the expansion valve, the expansion valve being configured to control the gas flow rate into the evaporator, the compressor is further provided with an inlet, the evaporator being connected to the inlet, the heat exchanger outlet is further connected to the expansion valve so that the gas condensate, after flowing out from the heat exchanger outlet, flows into the evaporator through the expansion valve and then into the compressor through the inlet to be re-converted into high-pressure gas for flowing into the heat exchanger of the seat heating control system for heat exchange, thereby enhancing the environmental friendliness of seat heating.

14. A vehicle, comprising a seat, an air conditioning system, the air conditioning system comprising a compressor with an outlet, the compressor being configured to compress low-pressure gas into high-pressure gas for output through the outlet, the vehicle further comprising:
a vehicle body; and
a seat heating control system, comprising:
a temperature sensor configured to sense the surface temperature of the seat;
a heat exchanger disposed on the seat;
an electronic throttle valve located between the outlet and the heat exchanger and configured to communicate with or isolate the compressor from the heat exchanger. When the compressor is connected to the heat exchanger, high-pressure gas flows into the heat exchanger for heat exchange, generating heat to heat the seat; and
a controller configured to determine whether the surface temperature is below a predetermined heating temperature; and control the electronic throttle valve to open when the surface temperature is determined to be below the predetermined heating temperature, and configured to control the electronic throttle valve to close when the surface temperature is determined to reach a predetermined cutoff temperature.

15. The vehicle according to claim 14, wherein when the surface temperature is determined to be greater than the predetermined heating temperature and less than the predetermined cutoff temperature, the electronic throttle valve adjusts the flow rate of the high-pressure gas flowing into the heat exchanger.

16. The vehicle according to claim 15, wherein when the surface temperature is determined to be greater than a predetermined adjustment temperature and less than the predetermined cutoff temperature, the electronic throttle valve decrease the flow rate, wherein the predetermined adjustment temperature is greater than the predetermined heating temperature and less than the predetermined cutoff temperature.

17. The vehicle according to claim 14, wherein the heat exchanger comprises a storage part, and a heat exchange part in communication with the storage part, the heat exchange part is located on the seat, the storage part stores heat exchange medium for heat exchange with the high-pressure gas to heat the seat.

18. The vehicle according to claim 17, wherein the heat exchange part comprises an upper heat exchange layer, and a lower heat exchange layer in communication, both the upper heat exchange layer and the lower heat exchange layer are composed of a plurality of heat exchange tubes, the heat exchange medium is located in both the upper heat exchange layer and the lower heat exchange layer, the upper heat exchange layer is adjacent to the seat and connected to a heat exchanger inlet, the lower heat exchange layer is connected to a heat exchanger outlet, the heat exchanger inlet is communicated with or isolated from the outlet via the electronic throttle valve.

19. The vehicle according to claim 18, wherein the high-pressure gas, after heat exchange with the heat exchange medium in the heat exchanger, is converted into a gas condensate and flows out from the heat exchanger outlet.

20. The vehicle according to claim 19, further comprising a condenser, an expansion valve, and an evaporator, the outlet is further connected to the condenser so that high-pressure gas output through the outlet and not flowing into the heat exchanger enters the condenser. The condenser is connected to the evaporator via the expansion valve, the expansion valve being configured to control the gas flow rate into the evaporator, the compressor is further provided with an inlet, the evaporator being connected to the inlet, the heat exchanger outlet is further connected to the expansion valve so that the gas condensate, after flowing out from the heat exchanger outlet, flows into the evaporator through the expansion valve and then into the compressor through the inlet to be re-converted into high-pressure gas for flowing into the heat exchanger of the seat heating control system for heat exchange, thereby enhancing the environmental friendliness of seat heating.
